(19) United States
(12) Patent Application Publication
(10) Pub. No.: US 2009/0015386 A1
(43) Pub. Date: Jan. 15, 2009

(54) RFID TAG HAVING AN IMPROVED OPERATIONAL SPEED AND OPERATING METHOD OF THE SAME

(76) Inventors: Hee Bok KANG, Chungcheongbuk-do (KR); Jin Hong AN, Gyeonggi-do (KR); Suk Kyoung HONG, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 12/166,476

(22) Filed: Jul. 2, 2008

(30) Foreign Application Priority Data
Jul. 10, 2007 (KR) 10-2007-0069035

(51) Int. Cl. H04Q 5/22

(52) U.S. Cl. 340/10.51

(57) ABSTRACT

A RFID tag and a method of operating it are disclosed which are capable of storing flag data for a period of time and comprises nonvolatile memory. The RFID tag includes an analog block for transmitting/receiving a command and a response by radio frequency and for providing a power-on reset signal and an operational voltage in accordance with the radio transmitting/receiving state. A digital block initiated by the power-on reset signal and supplied with the operational voltage provides a response corresponding to a command referring to storing data in the nonvolatile memory and generates the flag data representing the current data processing state and value. Finally, a short-term memory block supplied with the operational voltage and interfaced with the digital block stores and outputs the flag data via internal nonvolatile capacitors.

### CROSS-REFERENCE TO RELATED APPLICATIONS

The present application claims priority to Korean patent application number 10-2007-0069035 filed on Jul. 10, 2007, which is incorporated herein by reference in its entirety.

### BACKGROUND OF THE INVENTION

The present invention relates to a RFID device, and more particularly to a RFID tag and an operating method thereof which allow flag data to be stored for a period of time.

In general, a RFID (Radio Frequency Identification) device has been developed as a technology to automatically recognize objects using a radio frequency on which an electronic tag is attached and read information therefrom. The RFID device is capable of a rapid reorganization speed and a large amount of data storage, whereby it has been used in various applications such as stock management, supply net management, and plant automation.

The RFID device can be configured primarily with a RFID reader and a RFID tag. The RFID reader includes a built-in type or built-out type antenna, in which the antenna radiates an active signal to generate an electromagnetic field, i.e., RF field. The RFID tag is introduced within the RF field, the RFID tag receives the active signal radiated from the antenna of the RFID reader, and the information stored within the tag is transmitted to the RFID reader using the active signal received.

That is, when the RFID tag is introduced within the RF field, an alternating current inductive voltage is generated at an antenna coil equipped within the RFID tag. The inductive voltage is rectified into a DC voltage, which is used as a power supply necessary for the chip. The chip equipped in the RFID tag operates if a certain voltage is applied, and from this time, the data stored on the memory is transmitted to the RFID reader.

Since a prior RFID tags input the RF signal and generate the power supply voltage inside it, the power supply is suddenly interrupted in accordance with the RF signal state so that a current data processing state and value may disappear. Further, the prior RFID tag is initiated to process the data again if the power supply is supplied again, whereby the data processing speed can be decreased. Also, other changed data can be processed where the processing of the previous data has not completed.

Further, if multiple RFID tags exist within a read range of a single RFID reader, the multiple RFID tags can respond to it simultaneously. At this time, the signals provided from the multiple RFID tags intervene with each other, thereby causing collision. If a collision is caused, problems including an enlarged read time and wasted power occur since it repeatedly sends and receives the commands and the responses between the RFID reader and the RFID tags until the response of the tags is identified.

### SUMMARY OF THE INVENTION

There is provided a RFID tag of which an operational speed is improved.

There is provided a RFID tag which is allowed to store current data processing state and value for a period of time under a condition that power supply is interrupted.

The present invention can properly control operations of the RFID tags to enable them to operate without collision with each other if multiple RFID tags exist within a read range of a single RFID reader.

The RFID tag according to one embodiment of the present invention comprises a nonvolatile memory; an analog block transmitting and receiving a command signal and a response signal by radio frequency and providing a power-on reset signal and an operational voltage in accordance with a radio transmitting and receiving state; a digital block initiated by the power-on reset signal and supplied with the operational voltage provides the response signal that corresponds to the command signal for storing data to the nonvolatile memory and generate the flag data representing a present data processing state and value; and a short-term memory block supplied with the operational voltage and interfaced with the digital block to store and output the flag data via internal nonvolatile capacitors.

The RFID tag according to other embodiment of the present invention comprises a short-term memory block storing and outputting a flag data representing a present data processing state and value corresponding to a transmitting and receiving state of a command signal and a response signal via internal nonvolatile capacitors, wherein the short-term memory block comprises a first flag unit storing the flag data for a prescribed time regardless of whether a supply of an operational voltage is stopped or not in response to a power-on reset signal and a first write signal; and a second flag unit storing and maintaining the flag data when the operational voltage is supplied in response to the power-on reset signal and a second write signal and storing the flag data for more than the prescribed time when the supply of the operational voltage is stopped.

The operating method of the RFID tag according to still other embodiment of the present invention comprises a data processing step transmitting and receiving a command signal and a response signal by radio frequency and reading or writing data according to a power-on reset signal and generating operational voltage according to a radio transmitting and receiving state; a first flag step of storing a flag data representing a present data processing state and value for a prescribed time regardless of whether a supply of the operational voltage is stopped in response to a first write signal generated by the power-on reset signal and the command signal; and a second flag step of storing and maintaining the flag data when the operational voltage is supplied and storing the flag data for more than the prescribed time when the supply of the operational voltage is stopped in response to a second write signal generated by the power-on reset signal and the command signal.

### BRIEF DESCRIPTION OF THE DRAWINGS

FIG. 1 is a block diagram showing a RFID tag according to an embodiment of the present invention.

FIGS. 2A and 2B are waveform diagrams illustrating an operation of a flag ‘S1’ in the RFID tag according to an embodiment of the present invention.

FIGS. 3A and 3B are waveform diagrams illustrating an operation of flags ‘S2’, ‘S3’, ‘SL’ in the RFID tag according to an embodiment of the present invention.

FIG. 4 is a block diagram showing a detailed structure of a short-term memory block 400 in FIG. 1.

FIG. 5 is a block diagram showing a detailed structure of a first flag unit 410 in FIG. 4.

FIG. 6 is a circuit diagram showing a detailed structure of a first control unit 411 in FIG. 5.

FIG. 7 is a waveform diagram illustrating an operation of a first control unit 411 shown in detail in FIG. 6.

FIG. 8 is a circuit diagram showing a detailed structure of a first flag data storing/restoring unit 412 in FIG. 5.

FIG. 9 is a waveform diagram illustrating an operation upon restoring the flag data in FIG. 8.

FIGS. 10A and 10B are circuit diagrams showing a detailed structure of a persistent time adjusting unit 413 of FIG. 5.

FIG. 11 is a waveform diagram illustrating an operation of a persistent time adjusting unit 413 shown in detail in FIG. 10A.

FIG. 12 is a block diagram showing a detailed structure of a second flag unit 420 of FIG. 4.

FIG. 13 is a circuit diagram showing a detailed structure of a second control unit 421 of FIG. 12.

FIG. 14 is a circuit diagram showing a detailed structure of a second flag data storing/restoring unit 422 of FIG. 12.

FIG. 15 is a waveform diagram illustrating an operation of a second flag unit 420 shown in detail in FIG. 12.

### DESCRIPTION OF SPECIFIC EMBODIMENTS

Hereinafter, preferred embodiments of the present invention will be described in detail with reference to the accompanying drawings.

The present invention includes a short-term memory block having a first flag state maintaining flag data for a prescribed persistent time regardless of whether a power supply is interrupted or not and a second flag state maintaining the flag data for more than the prescribed persistent time only when the power supply is interrupted

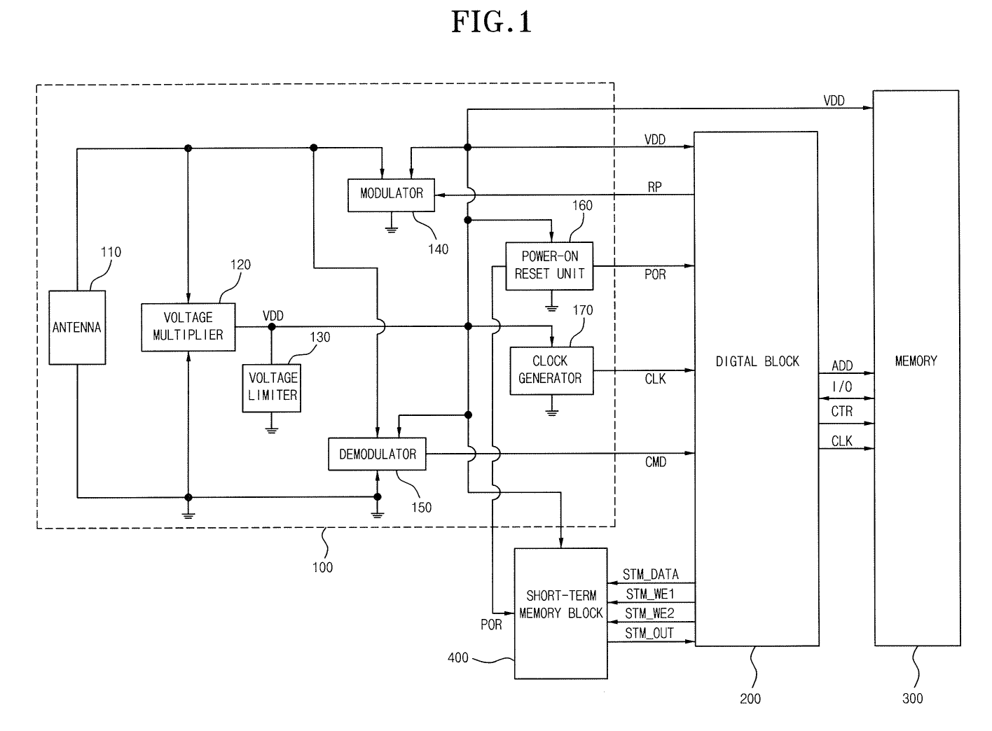

Specifically, referring to FIG. 1, the RFID tag according to the present invention includes an analog block 100, a digital block 200, a memory 300, and a short-term memory block 400.

The analog block 100 includes an antenna 110, a voltage multiplier 120, a voltage limiter 130, a modulator 140, a demodulator 150, a power-on reset unit 160, and a clock generator 170.

Herein, the antenna 110 transmits/receives the data to/from an external reader or writer via a radio frequency signal, and the voltage multiplier 120 generates an operational voltage VDD using the radio frequency signal applied from the antenna 110.

The voltage limiter 130 limits a magnitude of the operational voltage VDD outputted from the voltage multiplier 120, and the modulator 140 modulates a response signal RP applied from the digital block 200 and transmits it to the antenna 110. The demodulator 150 detects a command signal CMD from the radio frequency signal applied to the antenna 110 and transfers it to the digital block 200.

The power-on reset unit 160 senses the operational voltage VDD and outputs a power-on reset signal POR for controlling the reset operation to the digital block 200, and the clock generating unit 170 generates a clock CLK according to the operational voltage VDD and provides it to the digital block 200.

The digital block 200 receives the operational voltage VDD, the power-on reset signal POR, the clock CLK, and the command signal CMD from the analog block 100, and receives a data I/O from the memory 300, and receives a flag data STM_OUT from the short-term memory block 400. And then, the digital block 200 outputs the response signal RP to the modulator 140, outputs a address ADD, the data I/O, a control signal CTR, and the clock CLK to the memory 300, outputs the flag data STM_OUT and write signals STM_WE1, STM_WE2 to the short-term memory block 400.

The memory 300 uses a nonvolatile memory using a ferroelectric storage element to store and outputs the data I/O under a control of the digital block 200. The short-term memory block 400 stores and outputs the flag data STM_DATA in accordance with a state of write signals STM_WE1, STM_WE2 and restores the flag data STM_DATA in response to the power-on reset signal POR.

Herein, the short-term memory block 400 stores a prescribed state for a period of time when the operational voltage VDD supplied to the RFID tag is suddenly stopped or the flag data is changed, in which it maintains the stored value for only a short term in accordance with the flag state. Further, the short-term memory block 400 has a short programming time, i.e., short write time (about less than 2 ms).

The short-term memory block 400 has a flag state such as in table 1 below.

TABLE 1

| Flag | Power on | Power off |
|---|---|---|
| S0 | Indefinite | None |
| S1 | 500 ms < PT < 5 s | 500 ms < PT < 5 s |
| S2 | Indefinite | 2 s < PT |
| S3 | indefinite | 2 s < PT |
| SL | Indefinite | 2 s < PT |

As disclosed in the table 1, the flag “S0” has an operational function of a typical flip-flop.

The flag ‘S1’ maintains the flag data during a prescribed persistent time PT regardless of power on/off after writing the flag data and changes a value to 0 after the persistent time. For example, the persistent time of the flag data can be between 500 ms and 5 s as in the flag ‘S1’, shown in the table 1.

The flags ‘S2’, ‘S3’ and ‘SL’ maintain the flag data at the time of power-on after writing the flag data. The flags ‘S2’, ‘S3’ and ‘SL’ also memorize the value for a prescribed persistent time at the time of power-off and change a value to 0 after the persistent time. For example, the persistent time of the flag data can be more than 2 s as in the flags ‘S2’, ‘S3’ and ‘SL’, shown in the table 1.

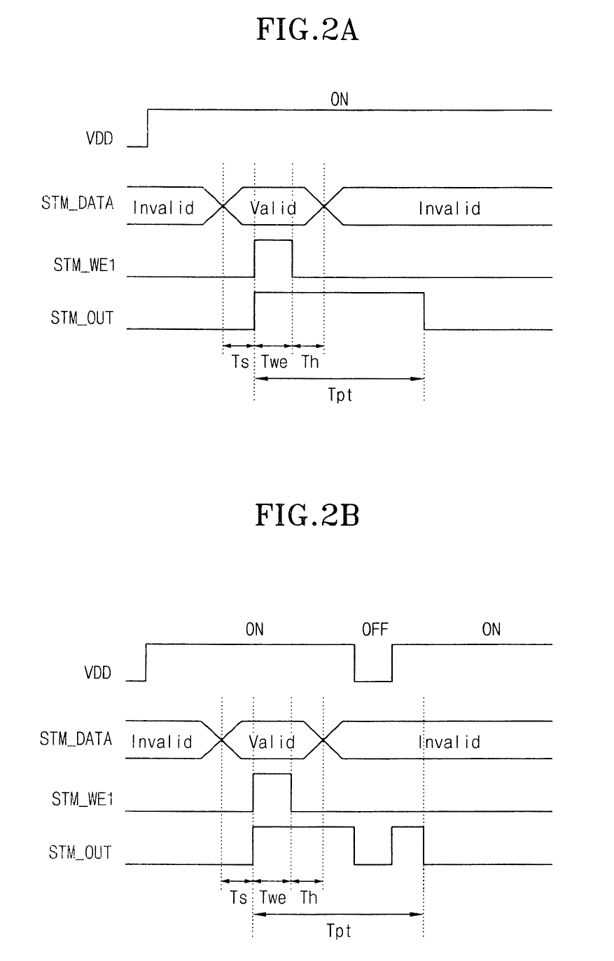

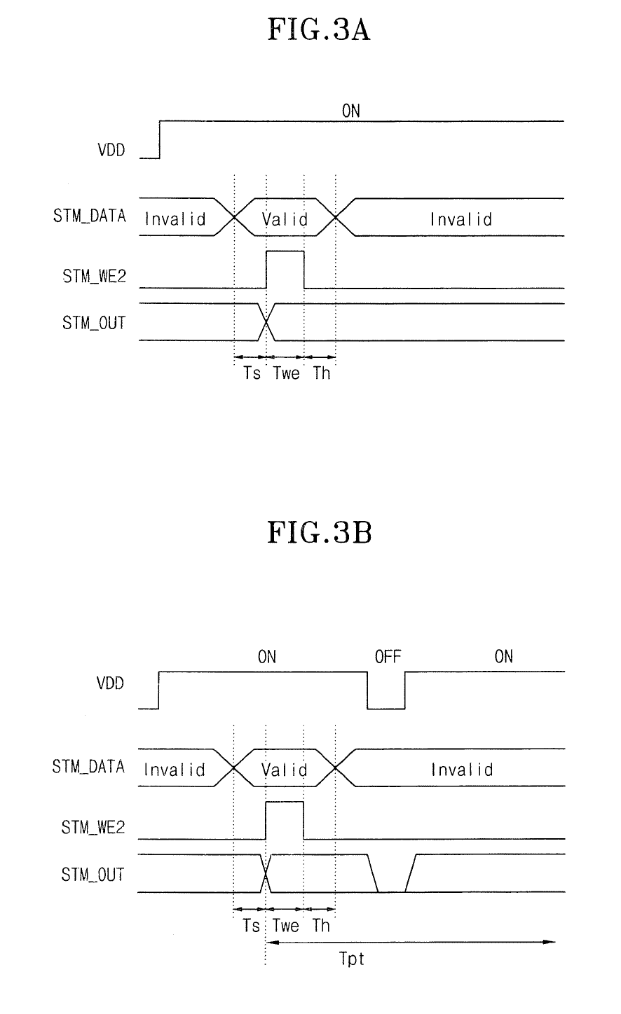

The state of the flag will be described more specifically referring to FIG. 2A, FIG. 2B, FIG. 3A, and FIG. 3B.

First, in view of the flag ‘S1’, if the flag data STM_DATA is inputted as a valid value after the operational voltage VDD becomes ON, the write signal STM_WE1 is enabled for a prescribed time Twe, as shown in FIG. 2A. At this time, the write signal STM_WE1 has an enable section Twe securing a margin having a setup time Ts and a hold time Th. The flag data STM_DATA is stored in the short-term memory block 400 for the prescribed persistent time Tpt from a time point when the write signal STM_WE1 is enabled and outputted as the flag data output signal STM_OUT for the persistent time Tpt.

Even in a case which the operational voltage VDD is turned off for a while at a state of the flag ‘S1’, the flag data STM_DATA is stored in the short-term memory block 400 for the prescribed persistent time Tpt from the time point when the write signal STM_WE1 is enabled, as shown in FIG. 2B. The flag data output signal STM_OUT is disabled while the operational voltage VDD is turned off, is enabled from a time point when the operational voltage VDD is turned on again, and is disabled again after the persistent time Tpt.

Next, in view of the flags ‘S2’, ‘S3’ and ‘SL’, if the flag data STM_DATA is inputted as a valid value after the operational voltage VDD is turned on, the write signal STM_WE2 is enabled, as shown in FIG. 3A. The flag data STM_DATA is stored in the short-term memory block 400 from a time point when the write signal STM_WE2 is enabled and outputted as the flag data output signal STM_OUT. The flag data output signal STM_OUT maintains an enable state until the operational voltage VDD is turned off.

If the operational voltage VDD is turned off during the state of the flags ‘S2’, ‘S3’ and ‘SL’, the flag data STM_DATA is stored in the short-term memory block 400 for a prescribed persistent time Tpt from a time point when the write signal STM_WE2 is enabled, as shown in FIG. 3B. Preferably, the persistent time Tpt is more than the persistent time Tpt of the flag ‘S1’.

As such, the short-term memory block 400 operates as short-term memory regardless of whether the power supply is ON or OFF in a case of the flag ‘S1’ and as short-term memory only when the power supply is OFF in cases of the flags ‘S2’, ‘S3’ and ‘SL’.

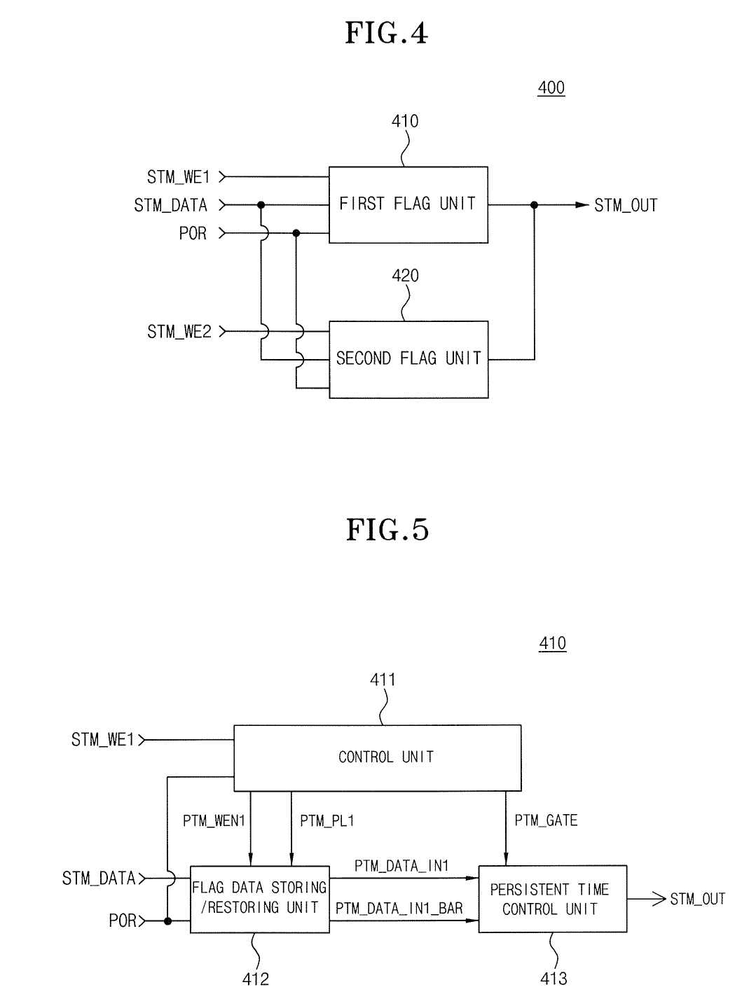

The short-term memory block 400 having such flag states can be configured with a first flag unit 410 corresponding to ‘S1’ and a second flag unit 420 corresponding to ‘S2’, ‘S3’, ‘SL’, as shown in FIG. 4.

The first flag unit 410 stores the flag data STM_DATA for a prescribed persistent time and outputs it as the flag data output signal STM_OUT in response to the write signal STM_WE1 provided from the digital block 200 regardless of whether the operational voltage VDD supply is stopped or not. If the supply of the operational voltage VDD is stopped for a while during the persistent time, the first flag unit 410 restores the flag data output signal STM_OUT in response to a power-on reset signal POR generated when the supply of the operational voltage VDD is restarted.

The second flag unit 420 stores and maintains the flag data STM_DATA in response to the write signal STM_WE2 provided from the digital block 200 and outputs it as the flag data output signal STM_OUT when the operational voltage VDD is supplied. The second flag unit 420 stores the flag data STM_DATA only for the prescribed persistent time and outputs it as the flag data output signal STM_OUT when the supply of the operational voltage VDD is stopped. If the supply of the operational voltage VDD is stopped during the storing of the flag data STM_DATA, the second flag unit 420 restores the flag data output signal STM_OUT in response to the power-on reset signal POR generated when the supply of the operational voltage VDD is restarted.

The first flag unit 410 can be configured with a control unit 411, a flag data storing/restoring unit 412, and a persistent-time control unit 413, as shown in FIG. 5.

The control unit 411 using the write signal STM_WE1 and the power-on reset signal POR generates a write control signal PTM_WEN1 establishing a write section, a plate signal PTM_PL1 controlling a storage state of the flag data STM_DATA, and a gate signal PTM_GATE controlling an output of the stored flag data STM_DATA.

The flag data storing/restoring unit 412 stores the flag data STM_DATA and outputs it as flag data input signals PTM_DATA_IN1, PTM_DATA_IN1_BAR in response to the write control signal PTM_WEN1 and the plate signal PTM_PL1 received from the control unit 411. And then, the flag data storing/restoring unit 412 restores the flag data input signals PTM_DATA_IN1, PTM_DATA_IN1_BAR to the flag data STM_DATA stored in response to the power-on reset signal POR.

The persistent-time control unit 413 inputs the flag data input signals PTM_DATA_IN1, PTM_DATA_IN1_BAR in response to the gate signal PTM_GATE received from the control unit 411 and outputs the flag data output signal STM_OUT corresponding to the flag data input signal PTM_DATA_IN1 or PTM_DATA_IN_BAR1 for the persistent time.

Herein, the control unit 411 can be configured with a write section setting unit which controls an enable section of the write signal STM_WE1 and outputs it as a write control signal PTM_WEN1; and a logical combination unit which logically combines the power-on reset POR signal with the write signal STM_WE1 and outputs it as the plate signal PTM_PL1 and the gate signal PTM_GATE.

The write section setting unit can be configured with a delay-driving unit delaying and driving the write signal STM_WE1 and a delay-capacity unit delaying an output state of the delay-driving unit. Herein, the number of delay-driving units and delay-capacity units can be one or more respectively. Each of the delay-driving units can be configured with a pull-up unit, a pull-down unit, and a current control unit.

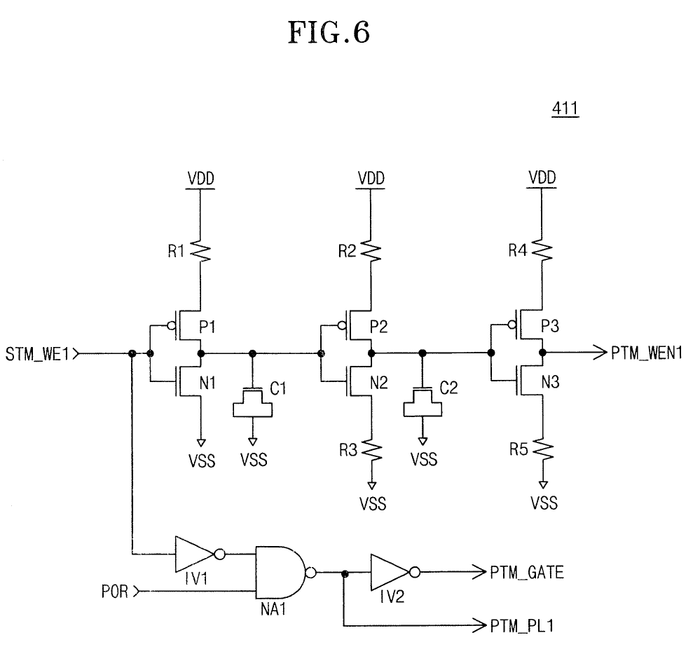

For example, the write section setting unit is configured with three delay-driving units and two delay-capacity units as shown in FIG. 6.

Referring to FIG. 6, the first delay-driving unit can be configured with a PMOS transistor P1, an NMOS transistor N1, and a resistor R1. Herein, the PMOS transistor P1 is connected between a resistor R1 and an NMOS transistor N1 and inputted a write signal STM_WE1 at a gate thereof. The PMOS transistor P1 pulls up an output terminal to a prescribed level in response to the write signal STM_WE1. The NMOS transistor N1 is connected between the PMOS transistor P1 and the ground voltage terminal VSS and inputted the write signal STM_WE1 at a gate thereof. The NMOS transistor N1 pulls down the output terminal to a prescribed level in response to the write signal STM_WE1. The resistor R1 is connected between the operational voltage terminal VDD and the PMOS transistor P1 to control a quantity of current flowing into the PMOS transistor P1 from the operational voltage terminal VDD.

The second delay-driving unit is connected to an output terminal of the first delay-driving unit. The second delay-driving unit configured with a PMOS transistor P2 pulling up an output terminal to a prescribed level in response to an output from the first delay-driving unit, an NMOS transistor N2 pulling down the output terminal to a prescribed level in response to the output from the first delay-driving unit, a resistor R2 controlling a quantity of current flowing into the PMOS transistor P2 from the operational voltage VDD, and a resistor R3 controlling a quantity of current flowing into the ground voltage VSS terminal from the NMOS transistor N2.

The third delay-driving unit is connected to an output terminal of the second delay-driving unit. The third delay-driving unit configured with a PMOS transistor P3 pulling up the output terminal outputting the write control signal PTM_WEN1 to a prescribed level in response to an output from the second delay-driving unit, an NMOS transistor N3 pulling down the output terminal to a prescribed level in response to the output from the second delay-driving unit, a resistor R4 controlling a quantity of current flowing into the PMOS transistor P3 from the operational voltage VDD, and a resistor R5 controlling a quantity of current flowing into the ground voltage terminal VSS from the NMOS transistor N3.

The first delay-capacity unit can be configured with a MOS capacitor C1 delaying the output from the first delay-driving unit. The MOS capacitor C1 is preferably a NMOS transistor having a gate connected in common to the output terminal of the first delay-driving unit and an input terminal of the second delay-driving unit, and a source and drain connected in common to the ground voltage terminal VSS.

The second delay-capacity unit can be configured with a MOS capacitor C2 delaying an output from the second driving unit. The MOS capacitor is preferably an NMOS transistor having a gate connected in common to the output terminal of the second delay-driving unit and an input terminal of the third delay-driving unit, and a source and a drain connected in common to the ground voltage VSS terminal.

The logical combination unit outputs the gate signal PTM_GATE and the plate signal PTM_PL1 enabled when any one of the write signal STM_WE1 and the power-on reset signal POR is enabled.

Herein, the logical combination unit can be configured with an inverter IV1 inverting the write signal STM_WE1, a NAND gate NA1 NAND-combining an output from the inverter IV1 with the power-on reset signal POR to output it as the plate signal PTM_PL1, and an inverter IV2 inverting the plate signal PTM_PL1 to output it as the gate signal PTM_GATE, as shown in FIG. 6.

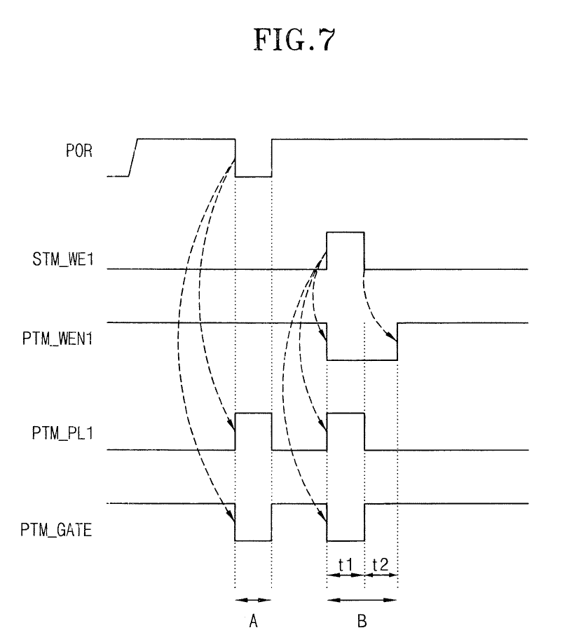

Referring to FIG. 7, an operation of the control unit will be specifically described. If the power-on reset signal POR is enabled at a logic low level, the plate signal PTM_PL1 is enabled at a logic high level and the gate signal PTM_GATE is enabled at a logic low level according to the logic combination unit.

If the write signal STM_WE1 is enabled at a logic high level where the power-on reset signal POR is disabled, the write control signal PTM_WEN1 is enabled at a logic low level according to the write section control unit, and the plate signal PTM_PL1 and the gate signal PTM_GATE are also enabled according to the logic combination unit.

Accordingly, the flag data STM_DATA is restored while the power-on reset signal POR is enabled (section ‘A’), and new flag data STM_DATA is stored while the write control signal PTM_WEN1 is enabled (section ‘B’). The enable section of the write control signal PTM_WEN1 can be set via the write section setting unit.

Further, data ‘0’ is stored while the plate signal PTM_PL1 is enabled (t1) and data ‘1’ is stored while the plate signal PTM_PL1 is disabled (t2) within section ‘B’.

As such, the control unit 411 controls that the flag data STM_DATA is restored when the power-on reset signal POR is enabled. The control unit 411 also controls that the flag data STM_DATA is stored when the write signal STM_WE1 is enabled.

The storage or restoration of the flag data can be performed via the flag data storing/restoring unit 412.

The flag data storing/restoring unit 412 can be configured with a transfer control unit transferring the flag data STM_DATA as the flag data input signal PTM_DATA_IN1 and the inverted flag data input signal PTM_DATA_IN1_BAR under the control of the write control signal PTM_WEN1 from the control unit 411. The flag data storing/restoring unit 412 also can be configured with a storage unit charging or discharging the flag data input signal PTM_DATA_IN1 and the inverted flag data input signal PTM_DATA_IN1_BAR in accordance with a state of an output from the transfer control unit and a state of the plate signal PTM_PL1, and a sense amplifying unit sensing and amplifying a potential difference between the flag data input signal PTM_DATA_IN1 and the inverted flag data input signal PTM_DATA_IN1_BAR in response to the power-on reset signal POR.

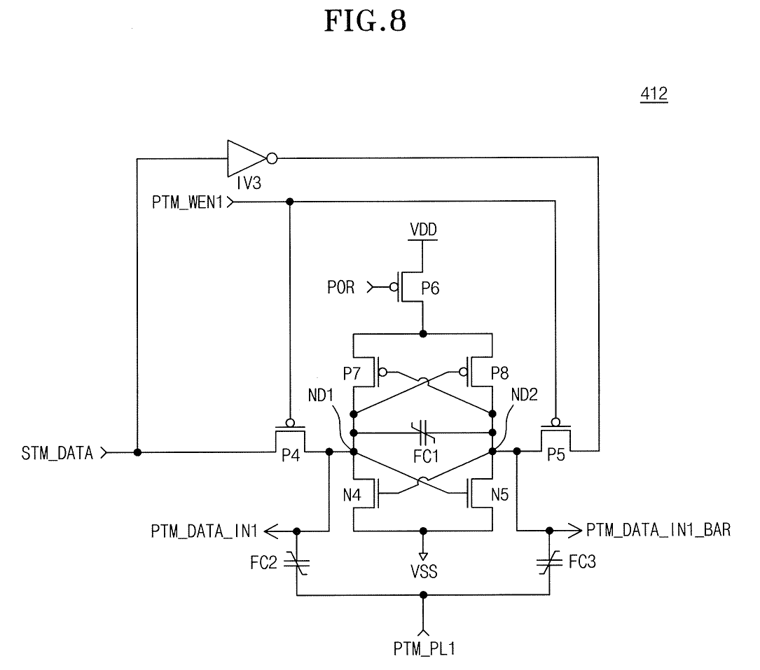

Further, the transfer control unit, the storage unit, and the sense amplifying unit can be configured as shown in FIG. 8.

Referring to FIG. 8, the transfer control unit comprises a first switch selectively transferring the flag data STM_DATA as the flag data input signal PTM_DATA_IN1 in accordance with a state of the write control signal PTM_WEN1, and a second switch selectively inverting the flag data STM_DATA and transferring it as the inverted flag data input signal PTM_DATA_IN1_BAR in accordance with a state of the write control signal PTM_WEN1.

The first switch can be configured with a PMOS transistor P4 transferring the flag data STM_DATA as the flag data input signal PTM_DATA_IN1 in response to the write control signal PTM_WEN1. The second switch can be configured with an inverter IV3 inverting the flag data STM_DATA and a PMOS transistor P5 transferring an output signal from the inverter IV3 as the inverted flag data input signal PTM_DATA_IN1_BAR in response to the write control signal PTM_WEN1.

Herein, if the first and the second switch are configured with PMOS transistor P4, P5 respectively, only junction leakage current can be generated when the flag data STM_DATA is not inputted. The result is that it is possible to reduce the leakage current effectively compared with the other elements (for example, a NMOS transistor).

For example, when the flag data STM_DATA becomes a logic low level where a logic high data is charged to the nonvolatile capacitors FC1, FC2, the write control signal PTM_WEN1 must be disabled at a logic low level if the first switch is an NMOS transistor. Therefore, a potential of a gate, a source and a bulk of the NMOS transistor becomes a logic low level, and a potential of a drain of the NMOS transistor becomes a logic high level, so that a large amount of leakage current can flow through the junction and the bulk of the NMOS transistor.

However, if the first switch is constructed with a PMOS transistor P4 under the same conditions, the write control signal PTM_WEN1 is disabled at a logic high level. Therefore, since only a potential of a drain of the PMOS transistor P4 becomes a logic low level and thus only junction leakage current is generated, the leakage current can be reduced.

The storage unit comprises a nonvolatile capacitor FC1 connected between a node ND1 to which a flag data input signal PTM_DATA_IN1 is transferred and a node ND2 to which an inverted flag data input signal PTM_DATA_IN1_BAR is transferred. The storage unit also comprises a nonvolatile capacitor FC2 connected between the node ND1 and a node to which the plate signal PTM_PL1 is inputted and a nonvolatile capacitor FC3 connected between the node ND2 and a node to which the plate signal PTM_PL1 is inputted. Herein, each of the nonvolatile capacitors FC1˜FC3 is preferably a ferroelectric capacitor.

The sense amplifying unit comprises a switch selectively supplying the operational voltage VDD in accordance with a state of the power-on reset signal POR and a differential amplifying unit sensing and amplifying a potential difference between the flag data input signal PTM_DATA_IN1 and the inverted flag data input signal PTM_DATA_IN1_BAR.

Herein, the switch can be configured with a PMOS transistor P6 providing the operational voltage VDD to the differential amplifier in response to the power-on reset signal POR. The differential amplifier can be configured with a PMOS transistor P7 connected between the switch and the node ND1, a PMOS transistor P8 connected between the switch and the node ND2, a NMOS transistor N4 connected between the node ND1 and the ground voltage terminal VSS, and a NMOS transistor N5 connected between the node ND2 and the ground voltage terminal VSS. The gates of the PMOS transistor P7 and the NMOS transistor N4 are connected in common to the node ND2 and the gates of the PMOS transistor P8 and the NMOS transistor N5 are connected in common to the node ND1.

The flag data storing/restoring unit 412 stores the flag data STM_DATA on the nonvolatile capacitors FC1˜FC3 while the write control signal PTM_WEN1 is enabled. The stored data is outputted as the flag data input signal PTM_DATA_IN1 and the inverted flag data input signal PTM_DATA_IN1_BAR correspondingly to a state of the plate signal PTM_PL1.

In addition, as the operational voltage VDD is supplied to the differential amplifier while the power-on reset signal POR is enabled, the data stored on the nonvolatile capacitors FC1˜FC3 is amplified and outputted as the flag data input signal PTM_DATA_IN1 and the inverted flag data input signal PTM_DATA_IN1_BAR.

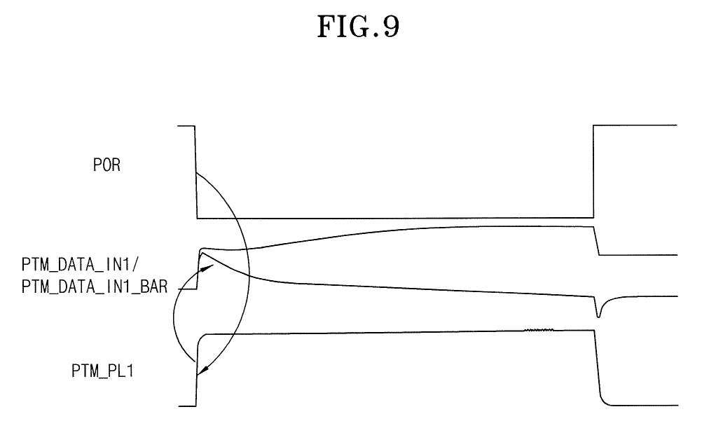

That is, referring to FIG. 9, the plate signal PTM_PL1 is enabled as the power-on reset signal POR is enabled. The potential difference between the flag data input signal PTM_DATA_IN1 and the inverted flag data input signal PTM_DATA_IN1_BAR is generated as the power-on reset signal POR and the plate signal PTM_PL1 are enabled. The flag data input signal PTM_DATA_IN1 and the inverted flag data input signal PTM_DATA_IN1_BAR are amplified and outputted as different logic levels from each other according to an operation of the differential amplifier.

As such, any one of the write control signal PTM_WEN1 and the reset signal POR is enabled so that the flag data input signal PTM_DATA_IN1 and the inverted flag data input signal PTM_DATA_IN1_BAR outputted from the flag data storing/restoring unit 412 is inputted to the persistent-time control unit 413. The persistent-time control unit 413 outputs the flag data output signal STM_OUT using only the flag data input signal PTM_DATA_IN1.

An operation of the persistent-time control unit 413 will be specifically described hereinafter. The persistent-time control unit 413 can be configured with a switching unit selectively transferring the flag data input signal PTM_DATA_IN1 in accordance with a state of the gate signal PTM_GATE, a delaying unit delaying for a prescribed time a time point when an output from the switching unit is disabled and outputting it as a delay time PTM_RC1, and a driving unit outputting the flag data output signal STM_OUT corresponding to the delay signal PTM_RC1 in response to the delay signal PTM_RC1.

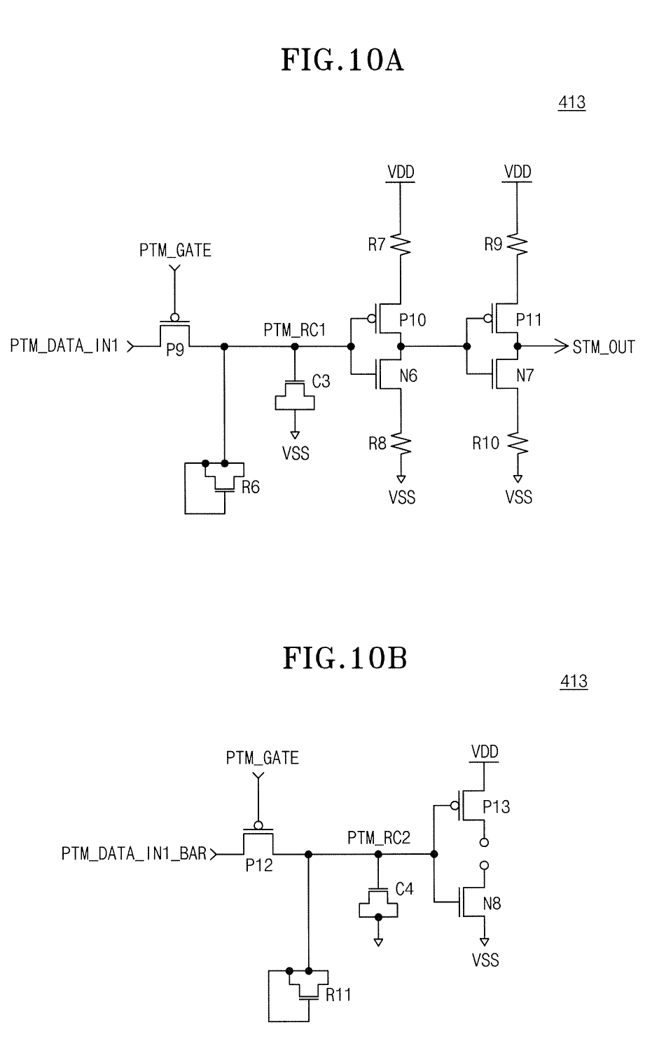

Hereinafter, the persistent-time control unit 413 will be specifically described comprising the switching unit, the delaying unit and the driving unit, referring to FIG. 10A. The switching unit can be configured with a PMOS transistor P9 which is turned on by the gate signal PTM_GATE to transfer the flag data input signal PTM_DATA_IN1.

If the switching unit is constructed with the PMOS transistor P9, there is an advantage in that the leakage current generated at the turn-off state can be effectively reduced, as explained above.

The delaying unit can be configured with a resistor element R6 and a capacitor element C3 connected to an output terminal of the switching unit. Herein, the resistor element R6 can be configured with an NMOS transistor having a gate, a drain, and a source connected in common to the output terminal of the switching unit. Further, the capacitor element C3 can be configured with an NMOS transistor having a gate connected to the output terminal of the switching unit and a drain and source connected to the ground voltage terminal VSS.

If the resistor element R6 is an NMOS transistor having a gate, a drain, and a source thereof connected in common to the output terminal of the switching unit, there is an advantage in that it is possible to effectively reduce the leakage current as compared with a general resistor connected between the output terminal of the switching unit and the ground voltage terminal VSS.

Further, the number of driving units can be one or more. In a case of two driving units, the first driving unit comprises a PMOS transistor P10 pulling up the output terminal to a prescribed level in response to the delay signal PTM_RC1, an NMOS transistor N6 pulling down the output terminal to a prescribed level in response to the delay signal PTM_RC1, a resistor R7 controlling a quantity of current flowing into the PMOS transistor P10 from the operational voltage terminal VDD, and a resistor R8 controlling a quantity of current flowing into the ground voltage terminal VSS from the NMOS transistor N6.

The second driving unit comprises a PMOS transistor P11 pulling up the flag output signal STM_OUT to a prescribed level in response to an output from the first driving unit, an NMOS transistor N7 pulling down the flag data output signal STM_OUT to a prescribed level in response to an output signal from the first driving unit, a resistor R9 controlling the quantity of current flowing into the PMOS transistor P11 from the operational voltage terminal VDD, and a resistor R10 controlling the quantity of current flowing into the ground voltage terminal VSS from the NMOS transistor N7.

The persistent-time control unit 413 further comprises a dummy control unit which inputs the inverted flag data input signal PTM_DATA_IN1_BAR according to the gate signal PTM_GATE and delays the inverted flag data input signal PTM_DATA_IN1_BAR corresponding to the delay of the flag data input signal PTM_DATA_IN1.

Herein, the dummy control unit is connected to an output terminal of the inverted flag data input signal PTM_DATA_IN1_BAR in order to prevent malfunction of the sense amplifying unit equipped in the flag data storing/restoring unit 412 and can be configured similar to the switching unit, the delay unit, and the driving unit.

Referring to FIG. 10B, the dummy control unit can be configured with a PMOS transistor P12 which is turned on by the gate signal PTM_GATE to transfer the inverted flag data input signal PTM_DATA_IN1_BAR, an element R11 having a resistive component connected to the output terminal of the PMOS transistor P12, an element C4 having a capacitive component connected to the output terminal of the PMOS transistor P12, and a PMOS transistor P13 inputting the signal PTM_RC2 delayed by the element R11 having the resistive component and the element C4 having the capacitive component at a gate thereof and having one end connected to the power supply voltage terminal VDD, and an NMOS transistor N8 inputting the delay signal PTM_RC2 at a gate thereof and having one end connected to the ground voltage terminal VSS.

Herein, the resistive element R11 can be constructed with an NMOS transistor having a gate, a drain, and a source thereof connected in common to the output terminal of the PMOS transistor P12. The element C4 having the capacitive component, can be constructed with an NMOS transistor having a gate connected to the output terminal of the PMOS transistor P12 and a drain and source connected to the ground voltage terminal VSS. The PMOS transistor P13 and the NMOS transistor N8 are open between them.

The persistent-time control unit 413 delays a state of the flag data input signal PTM_DATA_IN1 for a prescribed persistent time to output it as flag data output signal STM_OUT when the gate signal PTM_GATE is enabled.

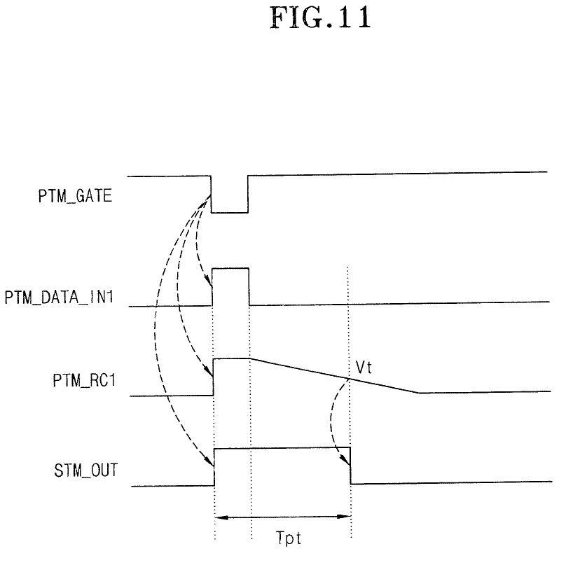

That is, referring to FIG. 11, if the flag data input signal PTM_DATA_IN1 is inputted as a logic high signal when the gate signal PTM_GATE is enabled at a logic low level, the delay signal PTM_RC1 obtained by RC delaying a logic high state of the flag data input signal PTM_DATA_IN1 is generated. The driving unit inputs the delay signal PTM_RC1 and outputs it as the flag data output signal STM_OUT.

The flag data output signal STM_OUT is outputted as a logic high state for the persistent time Tpt until the delay signal PTM_RC1 becomes less than the threshold voltage Vt of the PMOS transistor P10 and the NMOS transistor N6 of the driving unit at a logic high state.

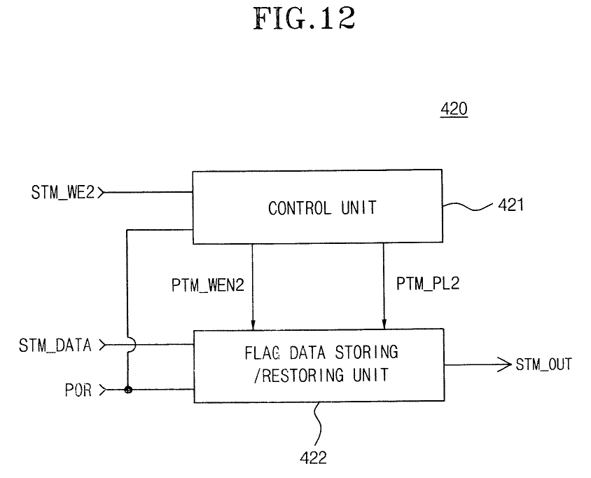

Meanwhile, the second flag unit 420 can be constructed with a control unit 421 and a flag data storing/restoring unit 422, as shown in FIG. 12.

The control unit 421 generates a plate signal TPM_PL2 and a write control signal PTM_WEN2 establishing the write section using the power-on reset signal POR and the write signal STM_WE2 for controlling a storing state of the flag data STM_DATA.

Additionally, the flag data storing/restoring unit 422 stores the flag data STM_DATA and outputs it as the output flag data signal STM_OUT according to the write control signal PTM_WEN2 and the plate signal PTM_PL2, and restores the output flag data signal STM_OUT to the stored flag data STM_DATA by the power-on reset signal POR.

Herein, the control unit 421 comprises a write section setting unit controlling an enable section of the write signal STM_WE2 and outputting it as the write control signal PTM_WEN2, and a logic combination unit logically combining the power-on reset POR signal with the write signal STM_WE2 to output the plate signal PTM_PL2.

The write section setting unit can be configured with a delay-driving unit to delay the write signal STM_WE2 and a delay-capacity unit delaying an output state of the delay-driving unit. Herein, the number of delay-driving units and delay-capacity units can be one or more respectively. Each of the delay-driving units can be configured with a pull-up unit, a pull-down unit, and a current control unit.

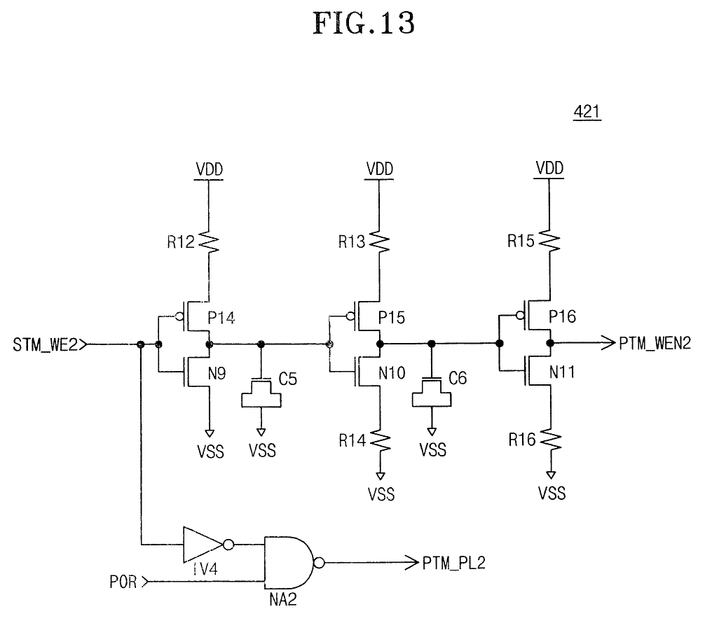

For example, the control unit 421 can be constructed as shown in FIG. 13. The write section setting unit is configured with three delay-driving units and two delay-capacity units.

Referring to FIG. 13, the first delay-driving unit comprises a PMOS transistor P14 pulling up an output terminal to a prescribed level in response to the write signal STM_WE2, an NMOS transistor N9 pulling down the output terminal to a prescribed level in response to the write signal STM_WE2, and a resistor R12 connected between the operational voltage terminal VDD and the PMOS transistor P14 to control a quantity of current flowing into the PMOS transistor P14 from the operating voltage terminal VDD.

The second delay-driving unit comprises a PMOS transistor P15 pulling up an output terminal to a prescribed level in response to an output from the first delay-driving unit, an NMOS transistor N10 pulling down the output terminal to a prescribed level in response to the output from the first delay-driving unit, a resistor R13 controlling a quantity of current flowing into the PMOS transistor P15 from the operating voltage terminal VDD, and a resistor R14 controlling a quantity of current flowing into the ground voltage terminal VSS from the NMOS transistor N10.

The third driving unit comprises a PMOS transistor P16 pulling up an output terminal from which the write control signal PTM_WEN2 is outputted to a prescribed level in response to an output from the second delay-driving unit, a NMOS transistor N11 pulling down the output terminal to a prescribed level in response to the output from the second delay-driving unit, a resistor R15 controlling a quantity of current flowing into the PMOS transistor P16 from the operating voltage terminal VDD, and a resistor R16 controlling a quantity of current flowing into the ground voltage terminal VSS from the NMOS transistor N11.

The first delay-capacity unit can be constructed with a MOS capacitor C5 delaying an output from the first delay-driving unit. The MOS capacitor C5 preferably has a gate connected in common to an output terminal of the first delay-driving unit and an input terminal of the second delay-driving unit, and a source and a drain connected in common to the ground voltage terminal VSS.

The second delay-capacity unit can be constructed with a MOS capacitor C6 delaying an output from the second delay-driving unit. The MOS capacitor C6 preferably has a gate connected in common to an output terminal of the second delay-driving unit and an input terminal of the third delay-driving unit, and a source and a drain connected in common to the ground voltage terminal VSS.

The logical combination unit outputs the plate signal PTM_PL2 enabled when any one of the write signal STM_WE2 and the power-on reset signal POR is enabled.

Herein, the logical combination unit comprises an inverter IV4 inverting the write signal STM_WE2 and a NAND gate NA2 NAND-combining an output from the inverter IV4 with the power-on reset signal POR to output the plate signal PTM_PL2, as shown in FIG. 13.

The flag data storing/restoring unit 422 can be configured with a transfer control unit, a storage unit, a sense amplifier, and a latch unit.

Herein, the transfer control unit transfers the flag data STM_DATA as the flag data input signal PTM_DATA_IN2 and the inverted flag data input signal PTM_DATA_IN2_BAR under the control of the write control signal PTM_WEN2.

The storage unit charges and discharges the flag data input signal PTM_DATA_IN2 and the inverted flag data input signal PTM_DATA_IN2_BAR in accordance with an output from the transfer control unit and a state of the plate signal PTM_PL2.

The sense amplifier senses and amplifies a potential difference between the flag data input signal PTM_DATA_IN2 and the inverted flag data input signal PTM_DATA_IN2_BAR in response to the power-on reset signal POR.

The latch unit outputs the flag data output signal STM_OUT corresponding to the flag data input signal PTM_DATA_IN2 as the flag data input signal PTM_DATA_IN2 and the inverted flag data input signal PTM_DATA_IN2_BAR and latches the flag data input signal PTM_DATA_IN2.

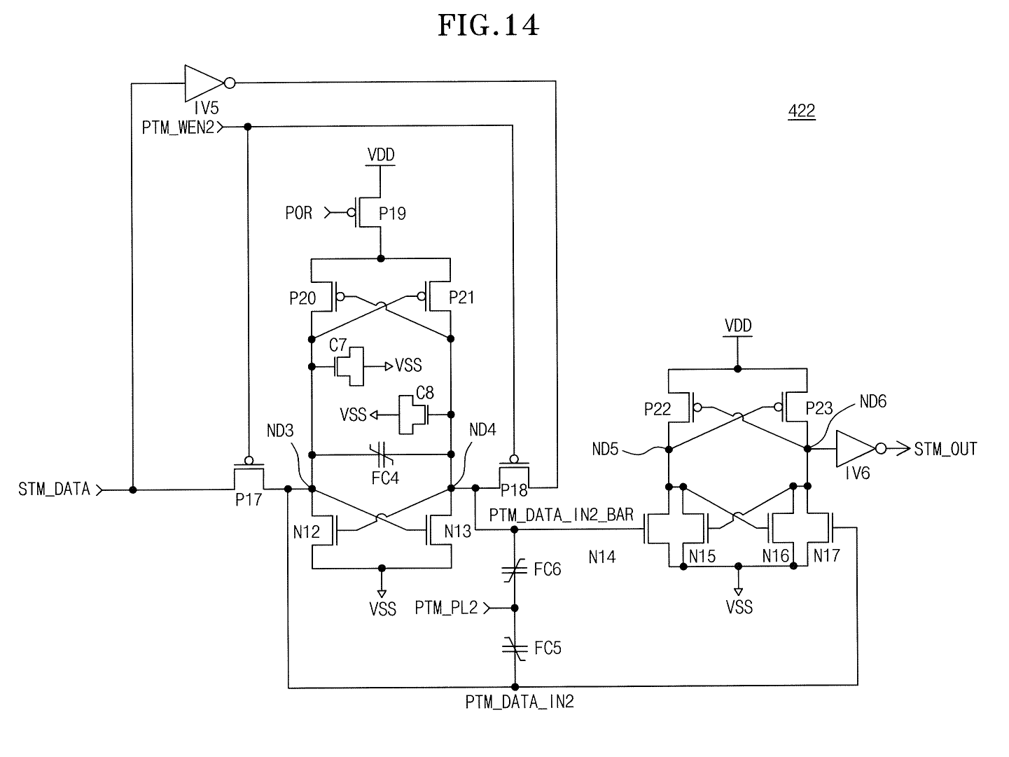

The transfer control unit, storage unit, sense amplifier and latch unit can be constructed as shown in FIG. 14.

Referring to FIG. 14, the transfer control unit can be configured with a first switch selectively transferring the flag data STM_DATA as the flag data input signal PTM_DATA_IN2 in accordance with a state of the write control signal PTM_WEN2 and a second switch selectively inverting the flag data STM_DATA and transferring it as the inverted flag data input signal PTM_DATA_IN2_BAR in accordance with a state of the write control signal PTM_WEN2.

Herein, the first switch can be configured with a PMOS transistor P17 transferring the flag data STM_DATA as the flag data input signal PTM_DATA_IN2 in response to the write control signal PTM_WEN2. The second switch can be configured with an inverter IV5 inverting the flag data STM_DATA and a PMOS transistor P18 transferring an output from the inverter IV5 as the inverted flag data input signal PTM_DATA_IN2_BAR in response to the write control signal PTM_WEN2.

If the first and second switches are configured with PMOS transistors P17, P18 respectively, junction leakage current can only be generated when the flag data STM_DATA is not inputted. Therefore, it is possible to efficiently reduce the leakage current compared with other elements (e.g., NMOS transistor).

The storage unit comprises a nonvolatile capacitor FC4 connected between a node ND3 to which the flag data input signal PTM_DATA_IN2 is transferred and a node ND4 to which an inverted flag data input signal PTM_DATA_IN2_BAR is transferred. The storage unit also comprises a nonvolatile capacitor FC5 connected between the node ND3 and a node to which the plate signal PTM_PL2 is inputted and a nonvolatile capacitor FC6 connected between the node ND4 and a node to which the plate signal PTM_PL2 is inputted. Herein, each of the nonvolatile capacitors FC4˜FC6 is preferably a ferroelectric capacitor.

The sense amplifying unit includes a switch selectively supplying the operational voltage VDD in accordance with a state of the power-on reset signal POR and a differential amplifying unit sensing and amplifying a potential difference between the flag data input signal PTM_DATA_IN2 and the inverted flag data input signal PTM_DATA_IN2_BAR according to a supply of the operational voltage VDD.

Herein, the switch can be configured with a PMOS transistor P19 providing the operational voltage VDD to the differential amplifier in response to the power-on reset signal POR. The differential amplifier can be configured with a PMOS transistor P20 connected between the switch and the node ND3, a PMOS transistor P21 connected between the switch and the node ND4, an NMOS transistor N12 connected between the node ND3 and the ground voltage terminal VSS, an NMOS transistor N13 connected between the node ND4 and the ground voltage terminal VSS, a MOS capacitor C7 connected between the node ND3 and the ground voltage terminal VSS, and a MOS capacitor C8 connected between the nod ND4 and the ground voltage terminal VSS. The gates of the PMOS transistor P20 and the NMOS transistor N12 are connected in common to the node ND4 and the gates of the PMOS transistor P21 and the NMOS transistor N13 are connected in common to the node ND3.

The latch unit differentially amplifies the flag data input signal PTM_DATA_IN2 and the inverted flag data input signal PTM_DATA_IN2_BAR to output the flag data output signal STM_OUT having the same logic level as the flag data input signal PTM_DATA_IN2 and at the same time latches the flag data input signal PTM_DATA_IN2.

Herein, the differential amplifier comprises a PMOS transistor P22 connected between the operational voltage terminal VDD and the node ND5, a PMOS transistor P23 connected between the operational voltage terminal VDD and the node ND6, two NMOS transistors N14, N15 connected between the node ND5 and the ground voltage terminal VSS, two NMOS transistors N16, N17 connected between the node ND6 and the ground voltage terminal VSS, and an inverter IV6 inverting a signal from the node ND6 to output it as the flag data output signal STM_OUT.

The gates of the PMOS transistor P22 and the NMOS transistor N15 are connected in common to the node ND6, and the gates of the PMOS transistor P23 and the NMOS transistor N16 are connected in common to the node ND5. The gate of the NMOS transistor N14 inputs the inverted flag data input signal PTM_DATA_IN2_BAR and the gate of the NMOS transistor N17 inputs the flag data input signal PTM_DATA_IN2.

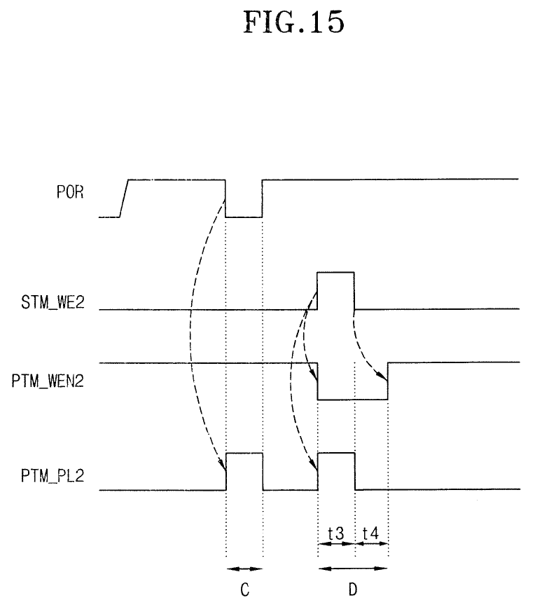

Hereinafter, the control unit 421 and the flag data storing/restoring unit 422 will be described specifically referring to FIG. 15. If the power-on reset signal POR is enabled at a logic low level, the plate signal PTM_PL2 is enabled at a logic high level by the logical combination unit equipped in the control unit 421.

At this time, while the power-on reset signal POR is enabled (section ‘C’), the flag data STM_DATA is restored via the flag data storing/restoring unit 422. The enabled section of the write control signal PTM_WEN2 can be set via the write section setting unit.

Where the power-on reset signal POR is disabled, if the write signal STM_WE2 is enabled at a logic high level, the write control signal PTM_WEN2 is enabled at a logic low level by the write section control unit equipped in the control unit 421. The plate signal PTM_PL2 is enabled by the logical combination unit equipped in the control unit 421.

The new flag data STM_DATA is stored via the flag data storing/restoring unit 422 while the write control signal PTM_WEN2 is enabled (section ‘D’). In section ‘D’, the data ‘0’ is stored while the plate signal PTM_PL2 is enabled (t3) and the data ‘1’ is stored while the plate signal TPM_PL2 is disabled (t4).

The flag data STM_DATA restored or stored as such is latched via the latch unit equipped in the flag data storing/restoring unit 422 and outputted as the flag data output signal STM_OUT.

As explained above, the RFID tag of the present invention stores the flag data representing the current data processing state and value for a period of time when the power supply is interrupted and performs the data processing operation with the stored flag data when the power supply is restarted again.

Therefore, the operational speed is improved and current data can be processed normally since the RFID tag of the present invention does not need to process the data from the beginning even though the power supply is interrupted and restarted again.

Further, the RFID tag of the present invention can operate as the flag ‘S1’ storing the flag data for a period of time regardless of whether the power supply is interrupted or not and as the flags ‘S2’, ‘S3’ and ‘SL’ storing the flag data for more than the prescribed time only when the power supply is interrupted, in accordance with a predetermined circumstance.

For example, if multiple RFID tags exist within the read range of a single RFID reader, the RFID tag transmitting the data to the RFID reader is operated according to the flag ‘S1’ and remaining RFID tags are operated according to the flags ‘S2’, ‘S3’ and ‘ SL’.

In this case, when one RFID tag transmits the data, remaining RFID tags maintain the current flag data. Then, if the data transmission is finished, the RFID tag transmitting the data to the RFID reader eliminates the current flag data and other RFID tags are operated according to the flag ‘S1’ to transmit the data to the RFID reader.

As such, if the multiple RFID tags exist within the read range of a single RFID reader, the multiple RFID tags can operate without causing a collision with each other so that the read time can be shortened and power waste can be reduced.

According to the RFID of the present invention, the circuit driving the prescribed signal is equipped with the elements R1˜R5, R7˜R10, R12˜R16 to control the current and the circuit controlling a transfer of the prescribed signal is configured with the elements P4, P5, P9, P17, P18 which are used to minimize the leakage current. Further, the resistor R6 discharges the charge in the capacitor C3 of the RC circuits to determine the flag data persistence time according to the flag ‘S1’ and is constructed with a MOS transistor using the leakage current within the junction and the channel.

As such, since the RFID tag of the present invention can store the flag data for a period of time with minimum power consumption. In addition, the operational speed of the RFID tag caused by storage of the flag data is not reduced largely.

The present invention stores the flag state of the RFID tags in accordance with a certain circumstance, thereby improving the operational speed.

Further, the present invention can store the current data processing state and value for a period of time using the short-term memory block when the power supply is interrupted, thereby improving the operational speed and preventing errors related to the current data processing.

Further, if multiple RFID tags exist within the read range of a single RFID reader, the present invention functions such that the RFID tag transmitting the data to the RFID reader stores the current flag data only during data processing time. Remaining RFID tags maintain the current flag data, whereby the RFID tags can operate without causing a collision with each other and thus shorten the reading time and reduce power consumption.

Those skilled in the art will appreciate that the specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

What is claimed is:

1. A RFID tag, comprising:
a nonvolatile memory;
an analog block transmitting and receiving a command signal and a response signal by radio frequency and providing a power-on reset signal and an operational voltage in accordance with a radio transmitting and receiving state;
a digital block initiated by the power-on reset signal and supplied with the operational voltage provides the response signal that corresponds to the command signal for storing data to the nonvolatile memory and generates flag data representing a present data processing state and value; and
a short-term memory block supplied with the operational voltage and interfaced with the digital block to store and output the flag data via internal nonvolatile capacitors.

2. The RFID tag as set forth in claim 1, wherein the short-term memory block maintains a storing state of the flag data for a prescribed time if a supply of the operational voltage is stopped and restores the stored flag data to output it to the digital block when the power-on reset signal is enabled.

3. The RFID tag as set forth in claim 2, wherein the short-term memory block operates according to any one of a first flag state that stores the flag data for the prescribed time and a second flag state that stores the flag data for more than the prescribed time when the supply of the operational voltage is stopped.

4. The RFID tag as set forth in claim 3, wherein the operation according to any one of the first and second flag states of the short-term memory block is performed according to a control signal of the digital block.

5. The RFID tag as set forth in claim 4, wherein the short-term memory block comprises:
a first flag unit storing the flag data for the prescribed time regardless of whether the supply of the operational voltage is stopped in response to the power-on reset signal and a first write signal provided from the digital block; and
a second flag unit storing and maintaining the flag data when the operational voltage is supplied and storing the flag data for more than the prescribed time when the supply of the operational voltage is stopped in response to the power-on reset signal and a second write signal provided from the digital block.

6. The RFID tag as set forth in claim 5, wherein the first flag unit comprises:
a control unit generating a first write control signal setting a write section, a first plate signal controlling a storing state of the flag data, and a gate signal controlling an output of the stored flag data in response to the power-on reset signal and the first write signal;
a flag data storing and restoring unit storing the flag data to output it as a first flag data input signal in response to the first write control signal and the first plate signal, and restoring the first flag data input signal to the stored flag data in response to the power-on reset signal; and
a persistent-time control unit receiving the first flag data input signal according to the gate signal and continuing to output a first flag data output signal corresponding to the first flag data input signal for the prescribed time.

7. The RFID tag as set forth in claim 6, wherein the control unit comprises:
a write section setting unit controlling an enable section of the first write signal to output the first write control signal; and
a logical combination unit logically combining the power-on reset signal with the first write signal to output the first plate signal and the gate signal.

8. The RFID tag as set forth in claim 7, wherein the write section setting unit comprises:
multiple delay-driving units connected in series delaying and driving the first write signal to output the first write control signal; and
multiple delay-capacity units connected between each of the delay-driving units to delay an output state of each delay-driving unit.

9. The RFID tag as set forth in claim 8, wherein each delay-driving unit comprises:
a pull-up unit selectively pulling up an output to a prescribed level in accordance with a state of the first write signal;
a pull-down unit selectively pulling down the output to a prescribed level in accordance with the state of the first write signal; and
a current control unit controlling at least one of a first current between the pull-up unit and a first voltage terminal to which the operational voltage of the pull-up unit is applied and a second current between the pull-down unit and a second voltage terminal to which the operational voltage of the pull-down unit is applied.

10. The RFID tag as set forth in claim 7, wherein the logical combination unit outputs the gate signal and the first plate signal enabled at a logic level different from each other when any one of the power-on reset signal and the first write signal is enabled.

11. The RFID tag as set forth in claim 6, wherein the flag data storing and restoring unit comprises:
a transfer control unit transferring the flag data as the first flag data input signal being non-inverted or inverted according to a control of the first write control signal;
a storage unit charging or discharging the non-inverted first flag data input signal and the inverted first flag data input signal according to state of the first plate signal and an output of the transfer control unit; and
a sense amplifier sensing and amplifying a potential difference between the non-inverted first flag data input signal and the inverted first flag data input signal in response to the power-on reset signal.

12. The RFID tag as set forth in claim 11, wherein the transfer control unit comprises:
a first switch selectively transferring the flag data as the non-inverted first flag data input signal according to a state of the first write control signal; and
a second switch selectively inverting the flag data and transferring it as the inverted first flag data input signal according to the state of the first write control signal.

13. The RFID tag as set forth in claim 11, wherein the storage unit comprises:
a first nonvolatile capacitor connected between a first node to which the non-inverted first flag data input signal is transferred and a second node to which the first plate signal is inputted;
a second nonvolatile capacitor connected between the second node and a third node to which the inverted first flag data input data is transferred; and
a third nonvolatile capacitor connected between the first node and the third node.

14. The RFID tag as set forth in claim 11, wherein the sense amplifying unit comprises:
a switch selectively supplying the operational voltage according to a state of the power-on reset signal; and
a differential amplifier supplied with the operational voltage to differentially amplify the non-inverted first flag data input signal and the inverted first flag data input signal.

15. The RFID tag as set forth in claim 6, wherein the persistent-time control unit comprises:
a switching unit selectively transferring the first flag data input signal according to a state of the gate signal;
a delay unit delaying a time point when an output from the switching unit is disabled for the prescribed time to output it as a delay signal; and
a driving unit outputting the first flag data output signal corresponding to the delay signal in response to the delay signal.

16. The RFID tag as set forth in claim 15, wherein the delay unit comprises a resistance element and a capacitance element connected to an output terminal of the switching unit.

17. The RFID tag as set forth in claim 16, wherein the resistance element comprises a MOS transistor having a gate, a drain, and a source thereof connected in common to an output terminal of the switching unit.

18. The RFID tag as set forth in claim 15, wherein the driving unit comprises:
a pull-up unit selectively pulling up the first flag data output signal to a prescribed level in accordance with a state of the delay signal;
a pull-down unit selectively pulling down the first flag data output signal to a prescribed level in accordance with the state of the delay signal; and
a current control unit controlling at least one of a first current between the pull-up unit and a first voltage terminal to which the operational voltage of the pull-up unit is applied and a second current between the pull-down unit and a second voltage terminal to which the operational voltage of the pull-down unit is applied.

19. The RFID tag as set forth in claim 15, wherein the persistent-time control unit further comprises a dummy control unit inputting the first flag data input signal inverted by the gate signal and delaying the inverted first flag data input signal corresponding to a delay of the first flag data input signal.

20. The RFID tag as set forth in claim 19, wherein the dummy control unit is constructed having a structure identical to the persistent-time control unit including the switching unit, the delay unit, and the driving unit.

21. The RFID tag as set forth in claim 5, wherein the second flag unit comprises:
a control unit generating a second write control signal setting a write section and a second plate signal controlling a storing state of the flag data in response to the power-on reset signal and the second write signal; and
a flag data storing and restoring unit storing the flag data and outputting it as an output flag data signal in response to the second write control signal and the second plate signal and restoring the output flag data signal to the stored flag data in response to the power-on reset signal.

22. The RFID tag as set forth in claim 21, wherein the control unit comprises:
a second write section setting unit controlling an enable section of the second write signal to output the second write control signal; and
a logical combination unit logically combining the power-on reset signal with the second write signal to output the second plate signal.

23. The RFID tag as set forth in claim 21, wherein the second write section setting unit comprises:
multiple delay-driving units delaying and driving the second write signal to output the second write control signal; and
multiple delay-capacity units connected between each of the delay-driving units to delay an output state of each delay-driving unit.

24. The RFID tag as set forth in claim 23, wherein each delay-driving unit comprises:
a pull-up unit selectively pulling up an output to a prescribed level in accordance with a state of the second write signal;
a pull-down unit selectively pulling down the output to a prescribed level in accordance with the state of the second write signal; and
a current control unit controlling at least one of a first current between the pull-up unit and a first voltage terminal to which the operational voltage of the pull-up unit is applied and a second current between the pull-down unit and a second voltage terminal to which the operational voltage of the pull-down unit is applied.

25. The RFID tag as set forth in claim 22, wherein the logical combination unit outputs the second plate signal enabled when any one of the power-on reset signal and the second signal is enabled.

26. The RFID tag as set forth in claim 21, wherein the flag data storing and restoring unit comprises:
a transfer control unit transferring the flag data as the second flag data input signal being non-inverted or inverted according to a control of the second write control signal;
a storage unit charging or discharging the non-inverted second flag data input signal and the inverted second flag data input signal according to state of the second plate signal and an output of the transfer control unit;
a sense amplifier sensing and amplifying a potential difference between the non-inverted second flag data input signal and the inverted second flag data input signal in response to the power-on reset signal; and
a latch unit outputting the flag data output signal corresponding to the non-inverted second flag data input signal as the non-inverted second flag data input signal and latching the flag data output signal for more than the prescribed time.

27. The RFID tag as set forth in claim 26, wherein the transfer control unit comprises:
a first switch selectively transferring the flag data as the non-inverted second flag data input signal according to a state of the second write control signal; and
a second switch selectively inverting the flag data to transfer it as the inverted second flag data input signal according to the state of the second write control signal.

28. The RFID tag as set forth in claim 26, wherein the storage unit comprises:
a first nonvolatile capacitor connected between a first node to which the non-inverted second flag data input signal is transferred and a second node to which the second plate signal is inputted;
a second nonvolatile capacitor connected between the second node and a third node to which the inverted second flag data input signal is transferred; and
a third nonvolatile capacitor connected between the first node and the third node.

29. The RFID tag as set forth in claim 26, wherein the sense amplifying unit comprises:
a switch selectively supplying the operational voltage according to a state of the power-on reset signal; and
a differential amplifier supplied with the operational voltage to differentially amplify the non-inverted second flag data input signal and the inverted second flag data input signal.

30. The RFID tag as set forth in claim 26, wherein the latch unit comprises a differential amplifier which differentially amplifies the non-inverted second flag data input signal and the inverted second flag data input signal to output the flag data output signal having a same logic level as that of the non-inverted second flag data input signal and latches the flag data output signal.

31. A RFID tag, comprising:
a short-term memory block storing and outputting a flag data representing a present data processing state and value corresponding to a transmitting and receiving state of a command signal and a response signal via internal nonvolatile capacitors, wherein the short-term memory block comprises:
a first flag unit storing the flag data for a prescribed time regardless of whether a supply of an operational voltage is stopped in response to a power-on reset signal and a first write signal; and
a second flag unit storing and maintaining the flag data when the operational voltage is supplied in response to the power-on reset signal and a second write signal and storing the flag data for more than the prescribed time when the supply of the operational voltage is stopped.

32. The RFID tag as set forth in claim 31, wherein the first flag unit comprises:
a control unit generating a first write control signal setting a write section, a first plate signal controlling a storing state of the flag data, and a gate signal controlling an output of the stored flag data in response to the power-on reset signal and the first write signal;
a flag data storing and restoring unit storing the flag data to output it as a first flag data input signal in response to the first write control signal and the first plate signal and restoring the first flag data input signal as the stored flag data in response to the power-on reset signal; and
a persistent-time control unit receiving the first flag data input signal according to the gate signal and outputting a first flag data output signal corresponding to the first flag data input signal for the prescribed time.

33. The RFID tag as set forth in claim 32, wherein the control unit comprises:
a write section setting unit controlling an enable section of the first write signal to output the first write control signal; and
a logical combination unit logically combining the power-on reset signal with the first write signal to output the first plate signal and the gate signal.

34. The RFID tag as set forth in claim 33, wherein the write section setting unit comprises:
multiple delay-driving units connected in series delaying and driving the first write signal to output the first write control signal; and
multiple delay-capacity units connected between each of the delay-driving units to delay an output state of each delay-driving unit.

35. The RFID tag as set forth in claim 34, wherein each delay-driving unit comprises:
a pull-up unit selectively pulling up an output to a prescribed level in accordance with a state of the first write signal;
a pull-down unit selectively pulling down the output to a prescribed level in accordance with the state of the first write signal; and
a current control unit controlling at least one of a first current between the pull-up unit and a first voltage terminal to which the operational voltage of the pull-up unit is applied and a second current between the pull-down unit and a second voltage terminal to which the operational voltage of the pull-down unit is applied.

36. The RFID tag as set forth in claim 33, wherein the logical combination unit outputs the gate signal and the first plate signal enabled at a logic level different from each other when any one of the power-on reset signal and the first write signal is enabled.

37. The RFID tag as set forth in claim 32, wherein the flag data storing and restoring unit comprises:
a transfer control unit transferring the flag data as the first flag data input signal being non-inverted or inverted according to a control of the first write control signal;
a storage unit charging or discharging the non-inverted first flag data input signal and the inverted first flag data input signal according to state of the first plate signal and an output of the transfer control unit; and
a sense amplifier sensing and amplifying a potential difference between the non-inverted first flag data input signal and the inverted first flag data input signal in response to the power-on reset signal.

38. The RFID tag as set forth in claim 37, wherein the transfer control unit comprises:
a first switch selectively transferring the flag data as the non-inverted first flag data input signal according to a state of the first write control signal; and
a second switch selectively inverting the flag data and transferring it as the inverted first flag data input signal according to the state of the first write control signal.

39. The RFID tag as set forth in claim 37, wherein the storage unit comprises:
a first nonvolatile capacitor connected between a first node to which the non-inverted first flag data input signal is transferred and a second node to which the first plate signal is inputted;
a second nonvolatile capacitor connected between the second node and a third node to which the inverted first flag data input data is transferred; and
a third nonvolatile capacitor connected between the first node and the third node.

40. The RFID tag as set forth in claim 37, wherein the sense amplifying unit comprises:
a switch selectively supplying the operational voltage according to a state of the power-on reset signal; and
a differential amplifier supplied with the operational voltage to differentially amplify the non-inverted first flag data input signal and the inverted first flag data input signal.

41. The RFID tag as set forth in claim 32, wherein the persistent-time control unit comprises:
a switching unit selectively transferring the first flag data input signal according to a state of the gate signal;
a delay unit delaying a time point when an output from the switching unit is disabled for the prescribed time to output it as a delay signal; and
a driving unit outputting the first flag data output signal corresponding to the delay signal in response to the delay signal.

42. The RFID tag as set forth in claim 41, wherein the delay unit comprises a resistance element and a capacitance element connected to an output terminal of the switching unit.

43. The RFID tag as set forth in claim 42, wherein the resistance element comprises a MOS transistor having a gate, a drain, and a source thereof connected in common to an output terminal of the switching unit.

44. The RFID tag as set forth in claim 41, wherein the driving unit comprises:
a pull-up unit selectively pulling up the first flag data output signal to a prescribed level in accordance with a state of the delay signal;
a pull-down unit selectively pulling down the first flag data output signal to a prescribed level in accordance with the state of the delay signal; and
a current control unit controlling at least one of a first current between the pull-up unit and a first voltage terminal to which the operational voltage of the pull-up unit is applied and a second current between the pull-down unit and a second voltage terminal to which the operational voltage of the pull-down unit is applied.

45. The RFID tag as set forth in claim 41, wherein the persistent-time control unit further comprises a dummy control unit inputting the first flag data input signal inverted by the gate signal and delaying the inverted first flag data input signal corresponding to a delay of the first flag data input signal.

46. The RFID tag as set forth in claim 45, wherein the dummy control unit is constructed having a structure identical to the persistent-time control unit including the switching unit, the delay unit, and the driving unit.

47. The RFID tag as set forth in claim 31, wherein the second flag unit comprises:
a control unit generating a second write control signal setting a write section and a second plate signal controlling a storing state of the flag data is response to the power-on reset signal and the second write signal; and
a flag data storing and restoring unit storing the flag data and outputting it as an output flag data signal in response to the second write control signal and the second plate signal and restoring the output flag data signal to the stored flag data in response to the power-on reset signal.

48. The RFID tag as set forth in claim 47, wherein the control unit comprises:
a second write section setting unit controlling an enable section of the second write signal to output the second write control signal; and
a logical combination unit logically combining the power-on reset signal with the second write signal to output the second plate signal.

49. The RFID tag as set forth in claim 48, wherein the second write section setting unit comprises:
multiple delay-driving units delaying and driving the second write signal to output the second write control signal; and
multiple delay-capacity units connected between each of the delay-driving units to delay an output state of each delay-driving unit.

50. The RFID tag as set forth in claim 49, wherein the delay-driving unit comprises:
a pull-up unit selectively pulling up an output to a prescribed level in accordance with a state of the second write signal;
a pull-down unit selectively pulling down the output to a prescribed level in accordance with the state of the second write signal; and
a current control unit controlling at least one of a first current between the pull-up unit and a first voltage terminal to which the operational voltage of the pull-up unit is applied and a second current between the pull-down unit and a second voltage terminal to which the operational voltage of the pull-down unit is applied.

51. The RFID tag as set forth in claim 48, wherein the logical combination unit outputs the second plate signal enabled when any one of the power-on reset signal and the second signal is enabled.

52. The RFID tag as set forth in claim 31, wherein the flag data storing and restoring unit comprises:
a transfer control unit transferring the flag data as the second flag data input signal being non-inverted or inverted according to a control of the second write control signal;
a storage unit charging or discharging the non-inverted second flag data input signal and the inverted second flag data input signal according to state of the second plate signal and an output of the transfer control unit;
a sense amplifier sensing and amplifying a potential difference between the non-inverted second flag data input signal and the inverted second flag data input signal in response to the power-on reset signal; and
a latch unit outputting the flag data output signal corresponding to the non-inverted second flag data input signal as the non-inverted second flag data input signal and latching the flag data output signal for more than the prescribed time.

53. The RFID tag as set forth in claim 52, wherein the transfer control unit comprises:
a first switch selectively transferring the flag data as the non-inverted second flag data input signal according to a state of the second write control signal; and
a second switch selectively inverting the flag data to transfer it as the inverted second flag data input signal according to the state of the second write control signal.

54. The RFID tag as set forth in claim 52, wherein the storage unit comprises:
a first nonvolatile capacitor connected between a first node to which the non-inverted second flag data input signal is transferred and a second node to which the second plate signal is inputted;
a second nonvolatile capacitor connected between the second node and a third node to which the inverted second flag data input signal is transferred; and
a third nonvolatile capacitor connected between the first node and the third node.

55. The RFID tag as set forth in claim 52, wherein the sense amplifying unit comprises:
a switch selectively supplying the operational voltage according to a state of the power-on reset signal; and
a differential amplifier supplied with the operational voltage to differentially amplify the non-inverted second flag data input signal and the inverted second flag data input signal.

56. The RFID tag as set forth in claim 52, wherein the latch unit comprises a differential amplifier which differentially amplifies the non-inverted second flag data input signal and the inverted second flag data input signal to output the flag data output signal having a same logic level as that of the non-inverted second flag data input signal and latches the flag data output signal.

57. An operating method of a RFID tag, comprising:
a data processing step transmitting and receiving a command signal and a response signal by radio frequency and reading or writing data according to a power-on reset signal and generating an operational voltage according to a radio transmitting and receiving state;
a first flag step of storing a flag data representing a present data processing state and value for a prescribed time regardless of whether a supply of the operational voltage is stopped in response to a first write signal generated by the power-on reset signal and the command signal; and
a second flag step of storing and maintaining the flag data when the operational voltage is supplied and storing the flag data for more than the prescribed time when the supply of the operational voltage is stopped in response to a second write signal generated by the power-on reset signal and the command signal.

58. The operating method of the RFID tag as set forth in claim 57, wherein the first flag step stores the flag data in response to the first write signal for the prescribed time and restores the flag data in response to the power-on reset signal.

59. The operating method of the RFID tag as set forth in claim 57, wherein the second flag step stores the flag data in response to the second write signal for more than the prescribed time and restores the flag data in response to the power-on reset signal.
